(19) United States
(12) Patent Application Publication
(10) Pub. No.: US 2026/0187566 A1
(43) Pub. Date: Jul. 2, 2026

(54) SYSTEMS AND METHODS FOR ANALYZING ORGANIZATION OPERATIONS

(71) Applicant: Daniel T. Towse, Davie, FL (US)

(72) Inventor: Daniel T. Towse, Davie, FL (US)

(21) Appl. No.: 19/003,669

(22) Filed: Dec. 27, 2024

(51) Int. Cl. G06Q 10/0637; G06Q 10/0631; G06Q 10/0639

(52) U.S. Cl. CPC G06Q 10/06375; G06Q 10/063114; G06Q 10/06393

(57) ABSTRACT

A system for the automated analysis of business operations is disclosed, including a processor to associate a group of inquiries of a plurality of inquiries with each strategic initiative of a plurality of strategic initiatives. A portion of the strategic initiatives are presented for selection. A portion of a group of inquiries associated with the selected strategic initiative(s) is presented. A response to the portion of the group of inquiries is received and each inquiry of the portion of the group of inquiries is associated with one or more metrics. Scores of each metric are determined and associated with the portion of the group of inquiries. Scores are based on the response to the portion of the group of inquiries. A progress indicator is presented to indicate a progress of a group of members of an organization in meeting a goal of the selected strategic initiative(s).

### CROSS-REFERENCE TO RELATED APPLICATIONS

The present application claims priority to U.S. Provisional Application No. 63/547,221 filed Nov. 3, 2023, titled “SYSTEMS, METHODS, AND MEDIA FOR GUIDING A TRANSFORMATION OF AN ORGANIZATION,” which is hereby incorporated by reference in its entirety.

### TECHNICAL FIELD

The embodiments disclosed herein generally relate to computerized systems for analyzing business operations and providing AI-driven recommendations for improving business practices.

### BACKGROUND

Companies both large and small can become disorganized, resulting in an inefficient workforce, lost profits, and general disarray. The workforce may become inefficient due to unclear or unarticulated goals for the company and/or personnel. In some cases, expansion can create disparate and siloed business ecosystems.

It is important for businesses to manage and analyze various aspects of their business operations in order to identify areas which need improvement and increase overall efficiency. Historically, businesses may have performed the task of analyzing business operations internally or may have hired a consulting firm. Internal analysis of the business causes the business to spend time and resources as well as may result in biased interpretations of the business practices. While consulting firms may remove the internal bias, they can be expensive and require a large team of consultants to produce an output. Manual analysis also takes a large amount of time and can include human error which further reduces the efficiency of the business.

### SUMMARY OF THE INVENTION

This summary is provided to introduce a variety of concepts in a simplified form that is further disclosed in the detailed description of the embodiments. This summary is not intended for determining the scope of the claimed subject matter.

A system for the automated analysis of business operations is disclosed, including a processor to associate a group of inquiries of a plurality of inquiries with each strategic initiative of a plurality of strategic initiatives. A portion of the strategic initiatives are presented for selection. A portion of a group of inquiries associated with the selected strategic initiative(s) is presented. A response to the portion of the group of inquiries is received and each inquiry of the portion of the group of inquiries is associated with one or more metrics. Scores of each metric are determined and associated with the portion of the group of inquiries. Scores are based on the response to the portion of the group of inquiries. A progress indicator is presented to indicate a progress of a group of members of an organization in meeting a goal of the selected strategic initiative(s).

In some aspects, the embodiments provide systems and methods for generating strategic roadmaps based on AI-driven analysis of organizational data inputs, including industry benchmarks, employee surveys, and operational metrics.

In some aspects, the system incorporates customizable templates based on predefined strategic initiatives and produces roadmaps specific to an organizations business model, operations targets, and industry standards.

In some aspects, the system includes an AI-driven multi-domain analysis tool capable of aligning organizational processes across four domains (Intent, Stewardship, Ecosystem, and Growth). The tool monitors each domain for deviations, identifies root causes, and suggests adjustments based on real-time data inputs.

In some aspects, the system includes an inflection point prediction module that uses machine learning to detect emerging risks or opportunities within an organization's culture, processes, or business metrics. The system generates alerts for executives based on historical trends, survey responses, and key performance indicators (KPIs), indicating the likelihood of strategic shifts.

In some aspects, the system operates a method for modeling strategic initiatives within a multi-value-chain framework, wherein AI evaluates dependencies and aligns different value chains (e.g., Sales, Finance, Human Resources). The AI evaluates resource requirements, predicts payback periods, and recommends adjustments for enhanced inter-departmental collaboration.

In some aspects, the system includes a feedback loop system that uses AI to issue prompts based on collected DILO studies, survey responses, and gap analyses. The prompts are used to identify pain points, inefficiencies, and process gaps. Feedback loops provide real-time insight into potential improvement areas within the organization's operational framework, mapped against strategic goals.

In some aspects, the system includes a KPI benchmarking system integrated into a SaaS platform that uses AI to analyze and compare organizational performance against industry standards. This system produces detailed KPI insights segmented by strategic, operational, and tactical layers, allowing the organization to view its performance within a broader ecosystem context.

In some aspects, the system includes a feature within the SaaS platform that integrates DILO study data into the organization's strategic assessment, mapping user workflows, and categorizing activities into value-added and non-value-added time. The AI leverages DILO data to identify root causes of workflow inefficiencies and feed insights into roadmap adjustments.

In some aspects, the system operates a method for capturing pain points through survey responses, DILO studies, and other organizational feedback, using AI to associate these pain points with specific strategic initiatives and roadmap milestones. Pain points are then mapped within the system, and AI suggests corresponding solutions or resources needed to resolve identified issues.

In some aspects, the system includes a SaaS system that supports multi-site and industry-specific strategic initiative management, allowing users to generate roadmaps for different business sites. Users can configure initiatives by industry type using NAICS codes, and AI adapts roadmaps based on site-specific demographics, operational maturity, and industry benchmarks.

In some aspects, the system includes an AI-powered prompt system integrated into executive dashboards that provides actionable insights and strategic recommendations. The system generates executive-level insights based on aggregated data across the four domains, simplifying complex data for easy interpretation and strategic action.

In some aspects, the one or more processors are further configured to cause a survey of questions to be presented on a display of the at least one user computing device. The processors also receive a response to the survey of questions from each of the plurality of the at least one user computing device.

In some aspects, the one or more metrics is comprised of at least one of the following: a strategic initiative metric, a safety metric, a transformation metric, a reliability metric, a strategy metric, a profitability metric, and a personnel metric.

In some aspects, the one or more scores is comprised of the following: an intent score, a stewardship score, an ecosystem score, a growth score, an environment score, a social score, a governance score, a maturity score, a logistics score, a production and operations score, a sales and marketing score, and a systems score.

In some aspects, the system includes an artificial intelligence engine to receive the response and to analyze the response to generate the one or more scores.

In some aspects, the artificial intelligence engine is operable to generate one or more recommendations using the one or more scores.

In some aspects, a timeline module displays one or more timelines associated with each of the one or more metrics, wherein the one or more timelines provide an estimated time for enacting a change to the business operations.

In some aspects, a reporting module displays, via a display module, one or more graphic representations of the one or more scores.

In some aspects, the system includes a survey generation module to generate the one or more inquiries.

In some aspects, the system includes a user input module to enable input of one or more responses to the one or more inquiries.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a system includes a computer or computing device operating an application. The application is configured to generate an interactive graphical user interface that includes at least a dashboard for guiding the transformation of an organization.

Other embodiments of this aspect include corresponding computer systems, apparatus, and computer programs recorded on one or more computer storage devices, each configured to perform the actions of the methods.

Implementations may include one or more of the following features. The above system, wherein the one or more hardware processors are further configured to cause a survey of questions to be presented on a display of a plurality of user devices; and receive a response to the survey of questions from each of the plurality of user devices. Implementations of the described techniques may include hardware, a method or process, or a computer tangible medium.

In one general aspect, a method may include associating a respective group of inquiries of a plurality of inquiries with each strategic initiative of a plurality of strategic initiatives; causing at least a portion of the plurality of strategic initiatives to be presented for selection; receiving a selection of at least one strategic initiative of at least the portion of the plurality of strategic initiatives; causing at least a portion of a group of inquiries associated with the selected at least one strategic initiative to be presented; receiving a response to at least the portion of the group of inquiries; associating each inquiry of at least the portion of the group of inquiries with one or more metrics; determining one or more scores of the one or more metrics associated with at least the portion of the group of inquiries, wherein the one or more scores are based on the response to at least the portion of the group of inquiries; and causing a progress indicator to be presented, wherein the progress indicator indicates a progress of a group of members of an organization in completing at least one process associated with the selected at least one strategic initiative. Other embodiments of this aspect include corresponding computer systems, apparatus, and computer programs recorded on one or more computer storage devices, each configured to perform the actions of the methods.

Implementations may include one or more of the following features. The above method, further comprising causing a survey of questions to be presented on a display of a plurality of user devices; and receiving a response to the survey of questions from each of the plurality of user devices. Implementations of the described techniques may include hardware, a method or process, or a computer tangible medium.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the computing system infrastructure, according to some embodiments;

FIG. 2 illustrates a block diagram of the application program operated by the computing system, according to some embodiments;

FIG. 3 illustrates a block diagram of the application program and data storage components, according to some embodiments;

FIG. 4 illustrates a flowchart of a method for the automated analysis of business operations, according to some embodiments;

FIG. 5 illustrates a flowchart of an exemplary process executed by the system and users thereof, according to some embodiments;

FIG. 6 illustrates a screenshot of the business transformation dashboard interface, according to some embodiments;

FIG. 7 illustrates a screenshot of the business unit transformation interface, according to some embodiments;

FIG. 8 illustrates a screenshot of the global analysis dashboard interface, according to some embodiments;

FIG. 9 illustrates a screenshot of the industry selection interface, according to some embodiments;

FIG. 10 illustrates a screenshot of the select role interface, according to some embodiments;

FIG. 11 illustrates a screenshot of the audit activity interface, according to some embodiments;

FIG. 12 illustrates a screenshot of the select action interface, according to some embodiments;

FIG. 13 illustrates a screenshot of the non-value activity interface, according to some embodiments;

FIG. 14 illustrates a screenshot of the image upload interface, according to some embodiments;

FIG. 15 illustrates a screenshot of the record activity interface, according to some embodiments;

FIG. 16 illustrates a screenshot of the document upload interface, according to some embodiments;

FIG. 17 illustrates a screenshot of the recording interface, according to some embodiments;

FIG. 18 illustrates a screenshot of the audit interface, according to some embodiments;

FIG. 19 illustrates a screenshot of the questionnaire interface, according to some embodiments;

FIG. 20 illustrates a screenshot of the roadmap interface, according to some embodiments;

FIG. 21 illustrates a screenshot of the survey results interface, according to some embodiments;

FIG. 22 illustrates a screenshot of the question collection interface according to some embodiments;

FIG. 23 illustrates a screenshot of the question prompt interface, according to some embodiments;

FIG. 24 illustrates a screenshot of the question editing interface, according to some embodiments;

FIG. 25 illustrates a screenshot of the score validation interface, according to some embodiments;

FIG. 26 illustrates a screenshot of the add questions interface, according to some embodiments;

FIG. 27 illustrates a screenshot of the strategic initiatives interface, according to some embodiments;

FIG. 28 illustrates a screenshot of the survey interface, according to some embodiments;

FIG. 29 illustrates a screenshot of the pain point interface, according to some embodiments;

FIG. 30 illustrates a screenshot of the KPI interface, according to some embodiments;

FIG. 31 illustrates a screenshot of the KPI interface, according to some embodiments;

FIG. 32 illustrates a screenshot of the KPI interface, according to some embodiments;

FIG. 33 illustrates a screenshot of the KPI score interface, according to some embodiments; and

FIG. 34 illustrates a schematic of a process for determining a KPI score according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to systems and methods for the automated analysis and characterization of business operations to enable the business to view the performance, efficiency, and success of various aspects of their business. The system may allow, for example, members of an organization (i.e., a business), including employees, executives, directs, managers, supervisors, junior level employees, contractors, etc. to input feedback into various prompts. This allows the system to analyze the user inputs and identify areas of improvement, areas which are successful, as well as other business-associated metrics.

As used herein, the term “user” is utilized to define a member of the organization and may include employees, executives, directs, managers, supervisors, junior level employees, contractors, etc. The application program enables users to create a user profile and indicate their user type such that the application program may grant, via a user module, specific permissions to each user type. This may be based on the role of the user creating the user account. For example, the application program may grant a CEO with administrative privileges.

In some embodiments, the AI engine and AI analytics layer is utilized for analyzing a series of prompts associated with each assessment.

In some embodiments, the multi-value chain framework is a category of assessment questionnaires that are domain specific to provide a business process maturity evaluation based on industry benchmarks associated with each aspect of the evaluation.

In some embodiments, real time inputs are received and can be refined and updated as organizations and/or business systems mature.

The system aggregates and processes data from various organizational sources, including key performance indicators (KPIs), employee feedback, and operational metrics. The system employs data normalization techniques to standardize inputs, ensuring consistency across diverse data types. Machine learning models analyze the aggregated data to identify patterns, trends, and anomalies.

Natural Language Processing (NLP) algorithms process qualitative feedback, extracting sentiments and recurring themes. The system compares organizational metrics against industry standards and historical data to assess performance. Benchmarking algorithms adjust for variables such as company size and market conditions to provide relevant comparisons.

Predictive models forecast future performance based on current data, helping organizations anticipate challenges and opportunities. Scenario analysis tools simulate the impact of potential strategic decisions on organizational outcomes.

During use, the user has access to the system functionalities while using a centralized dashboard displaying real-time analytics and visualizations. Interactive charts and graphs allow users to drill down into specific data points for detailed examination.

The interface offers customization options, enabling users to tailor the display to their roles and preferences. Widgets and modules can be rearranged, added, or removed to suit individual needs.

The system provides actionable insights, highlighting areas of strength and opportunities for improvement. Automated reports summarize key findings and can be scheduled for regular delivery to stakeholders.

Users can input feedback directly into the system, which is then incorporated into ongoing analyses. Collaboration tools facilitate communication among team members, fostering a data-driven decision-making culture.

Overall, the system combines sophisticated algorithms with an intuitive user interface to deliver meaningful organizational insights, empowering users to make informed strategic decisions.

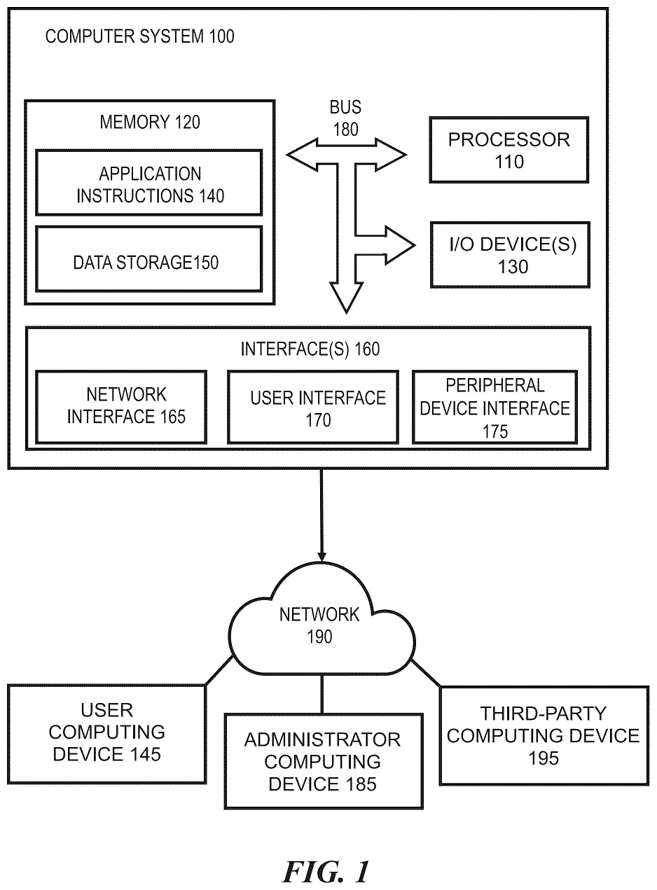

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

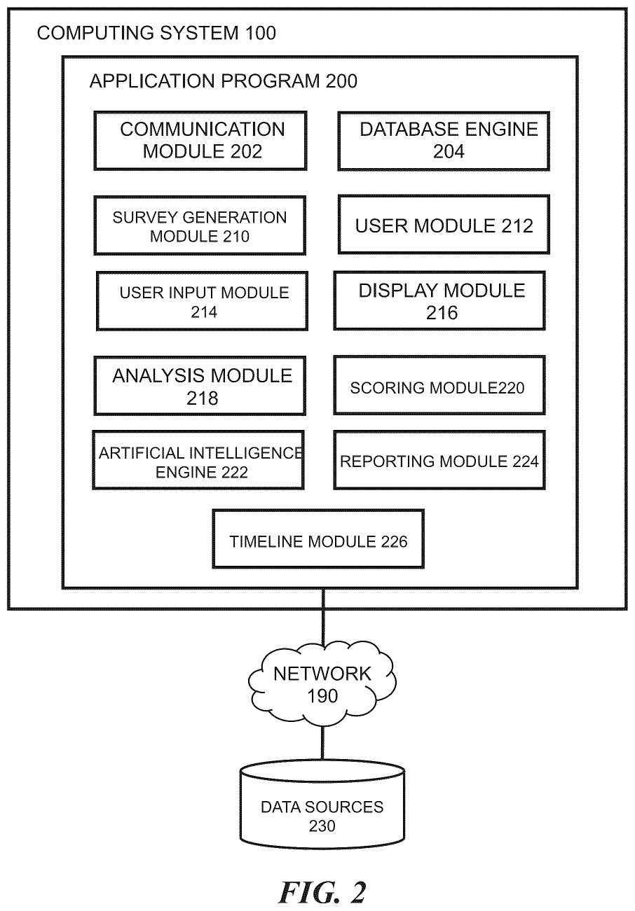

FIG. 2 illustrates an example computer architecture for the application program 200 operated via the computing system 100. The computing system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a survey generation module 210, a user module 212, user input module 214, a display module 216, an analysis module 218, a scoring module 220, an artificial intelligence (AI) engine 222, a reporting module 224, and a timeline module 226. The application program is in operable communication with data sources 230 via network 190.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

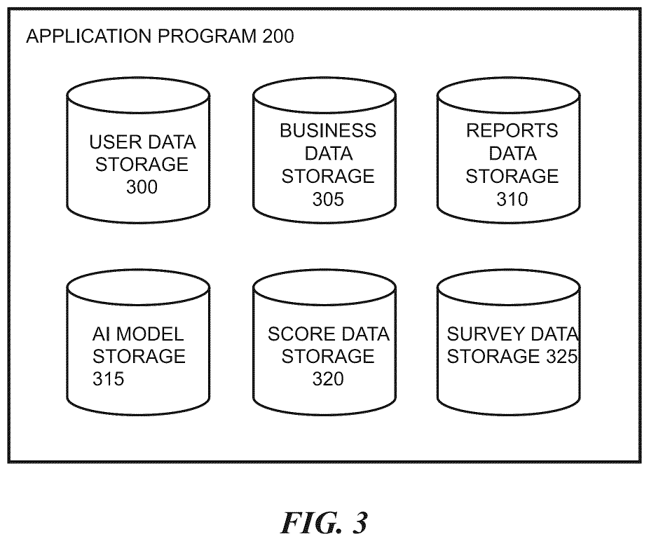

In some embodiments, the database engine 204 is in operable communication with one or more data sources 230 which may include the various data storage components described and illustrated in FIG. 3.

In some embodiments, the survey generation module 210 is operable to generate a plurality of surveys which are displayed on the user interface of the application program. The user may select from one or more surveys in a list which allows the user to input responses to each prompt/question/inquiry provided within the survey.

In some embodiments, the user module 212 facilitates the creation of a user account for the application system. The user module 212 may allow the user to create a user profile which includes user information, user preferences, and user-associated information. The user module 212 may also be used to assign a user type to each user.

In some embodiments, the user input module 214 enables users to input responses to survey questions. The responses may be written responses, selections of boxes, or other means of responding to an inquiry/question/prompt.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the display module 216 may be operable to display various information associated with each of the functionalities described herein. The display module 216 may, for example, display each metric, each strategic initiative, each score, surveys, user information, business/organization information, statistics, key measures (i.e., KPIs), strategic roadmaps, value chain processes, progress indicators, classifications (associated with ranges of scores, inquiries, prompts, graphical representations of various data points or groups of data points, timelines, and the like.

In some embodiments, analysis module 218 is in operable communication with the artificial intelligence engine 222 to analyze responses which have been input by the user. The analysis module 222 may output a written analysis, recommendation, report, etc. which can be used by the system and/or its users.

In some embodiments, a scoring module 220 is operable to generate a score associated with a strategic initiative, metric, or other element. The score generated by the scoring module 220 may then be used to establish a classification (e.g., pioneering, divergent, aspiring, competent, generative, etc.) which indicates the status of the business in a particular strategic initiative.

In some embodiments, the reporting module 224 is operable to generate reports associated with various aspects of the business's analysis by the system. Reports may be written, graphical, or otherwise represented and displayed.

In some embodiments, the timeline module 226 is operable to display one or more timelines which can be used to visualize progress when performing a task associated with improving a strategic initiative. The timeline module 226 may display progress associated with individuals, the business as a whole, key metrics, and the like. Each task may be grouped into various subtasks, thus providing a comprehensive view of progress towards each strategic initiative.

FIG. 3 illustrates the data storage components in communication with the application program 200. These may include a user data storage 300, a business data storage 305, a reports data storage 310, an AI model storage 315, a score data storage 320, and a survey data storage 325.

The user data storage 300 is capable of storing each user's personal data, historical usage data, user identity, user type, and the like. Each metric, score, performance data, and the like may be associated with each particular user they apply to.

The business data storage 305 is capable of storing business information, personnel information, strategic initiatives associated with the business, business goals, key performance indicators, and other business-associated information.

The reports data storage 310 is capable of storing reports which have been generating by the reporting module.

The AI model storage 315 stores operational instructions, algorithmic protocols, and additional information which may be utilized by the AI engine when performing tasks.

The score data storage 320 is capable of storing scores which relate to each metric and strategic initiative. The scores may be stored for reference to enable the monitoring of progress.

The survey data storage 325 is capable of storing survey inquiries and other general survey information which is used by the system to analyze business operations.

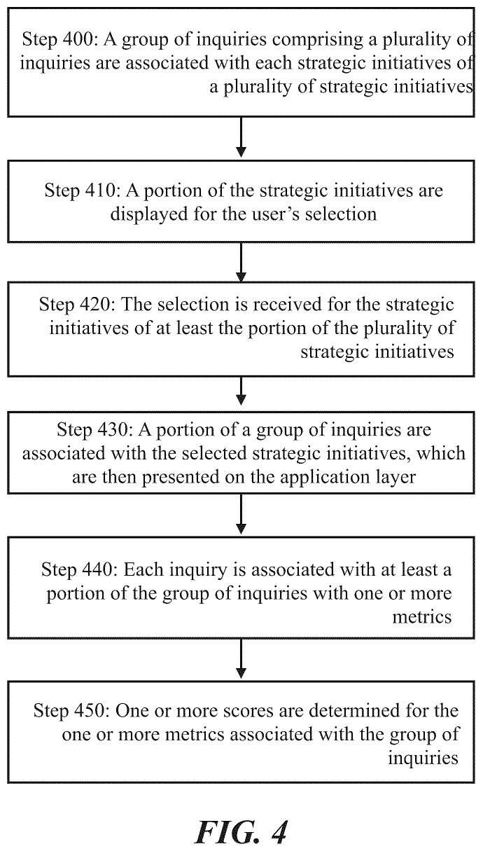

FIG. 4 illustrates a method for the automated analysis and characterization of business operations. In step 405, a group of inquiries comprising a plurality of inquiries are associated with each strategic initiative of a plurality of strategic initiatives. In step 410, a portion of the plurality of strategic initiatives are displayed for selection via a user. In step 420, the selection is received for the strategic initiative(s) of at least the portion of the plurality of strategic initiatives. In step 430, at least a portion of a group of inquiries are associated with the selected strategic initiative(s) which are then presented. In step 440, each inquiry is associated with at least a portion of the group of inquiries with one or more metrics. In step 450, one or more scores are determined for the one or more metrics associated with at least the portion of the group of inquiries. The one or more scores are based on the response to at least a portion of the group of inquiries. In step 460, a progress indicator is displayed. The progress indicator indicates a progress of a group of members of an organization in completing at least one process associated with the selected strategic initiative(s).

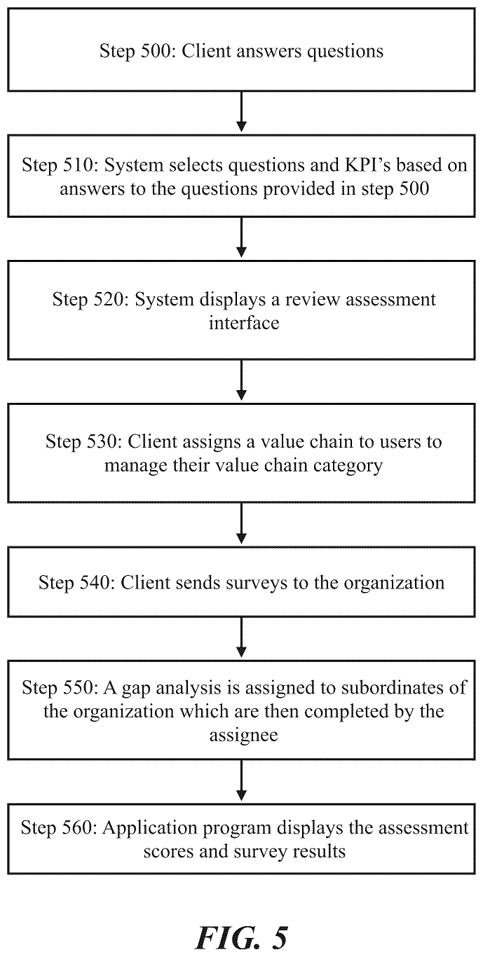

FIG. 5 illustrates a flowchart for a process executed by the system. In step 500, the client logs into the system and answers various questions. This may include selecting strategic initiatives, selecting an industry, selection a location, inputting project name, and inputting a number of employees associated with an organization and/or project. In step 510, the system selects questions and KPI's based on the previously provided answers. In step 520, the system displays a review assessment interface. In step 530, the client assigns a value chain to users to manage their value chain category. In step 540, the client sends surveys to the organization. In step 550, gap analysis is assigned to subordinates of the SME which are then completed by the subordinates. In step 560, the assessment scores and survey results are displayed.

Assessment attributes are weighted against each assessment gap question and survey results establishing the baseline gap.

As the gap closure questions are answered and the surveys are gathered, a picture starts to emerge on the health of the organization and the effort required to achieve the strategic initiative(s) becomes clear.

With multiple initiatives, the user can model different initiatives by priority to understand the most efficient path towards the desired target operating model.

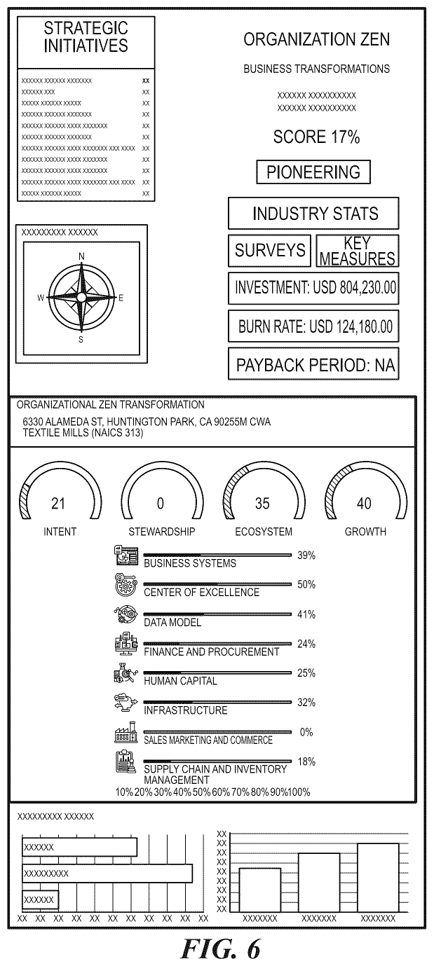

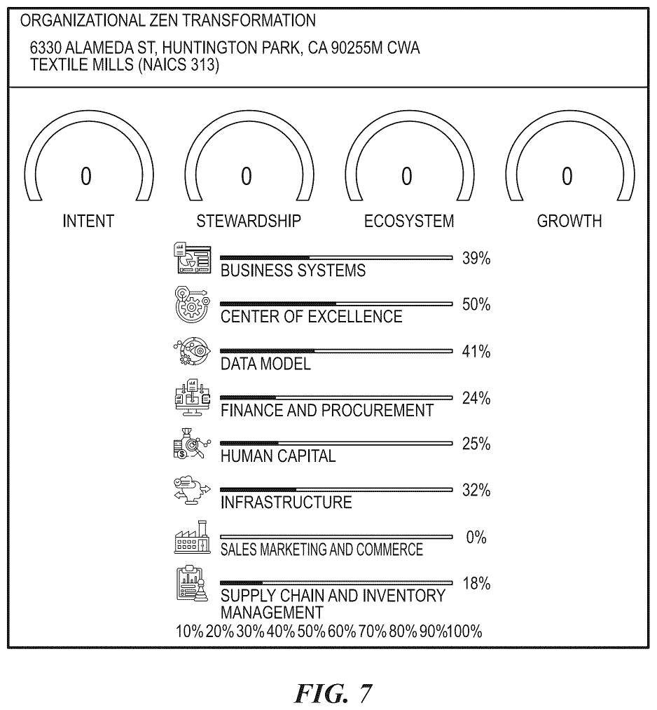

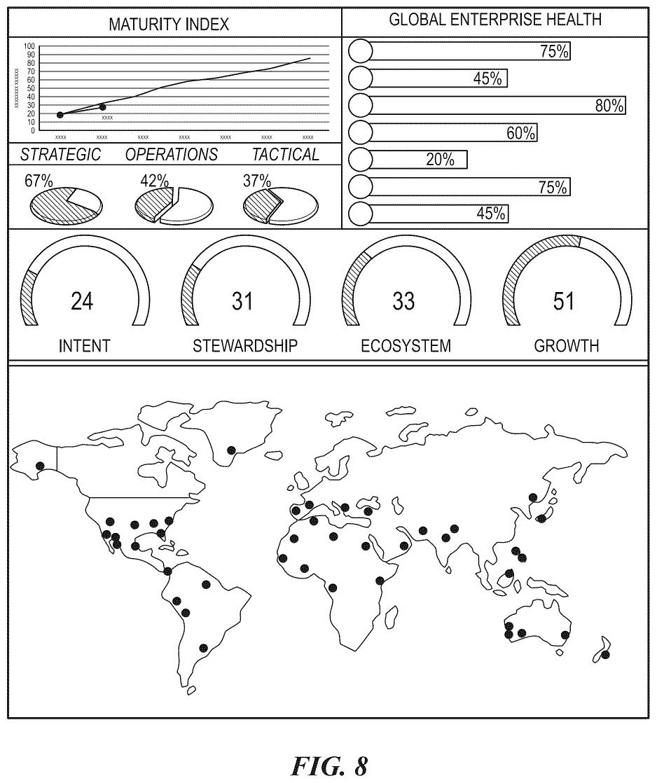

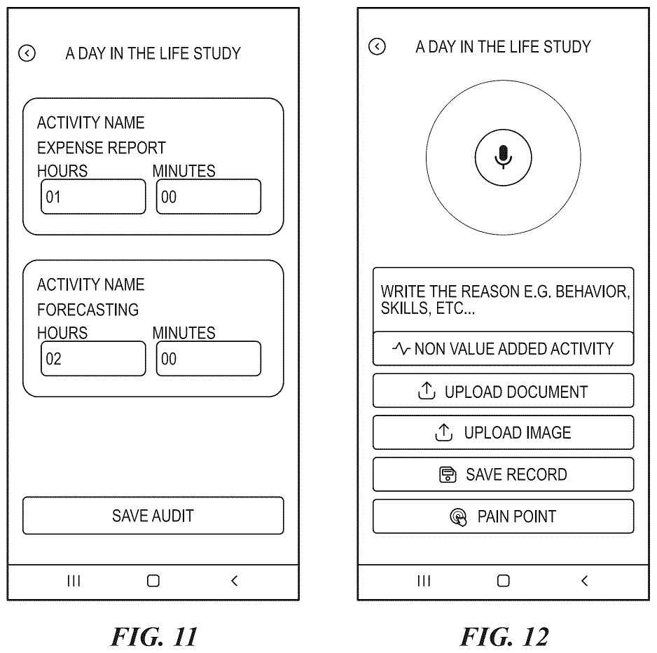

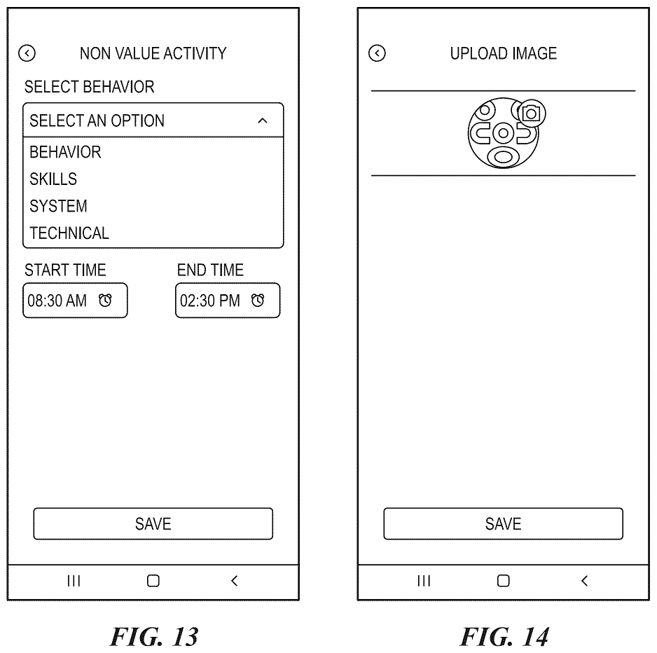

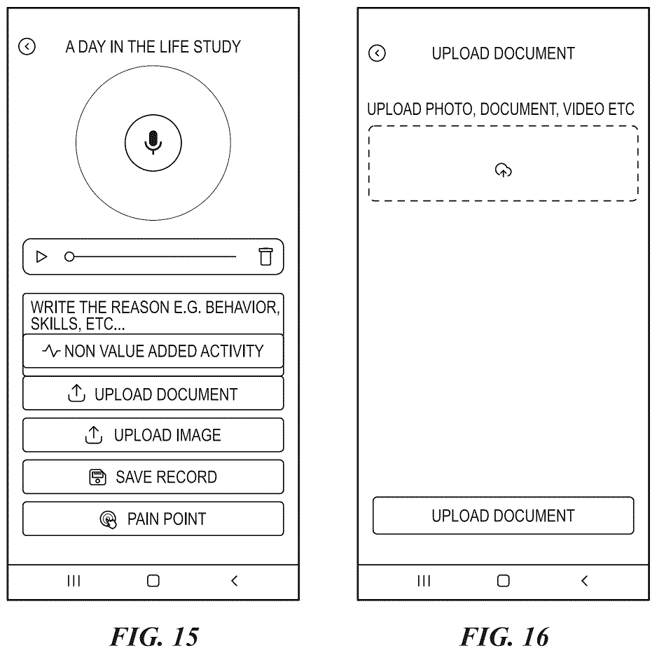

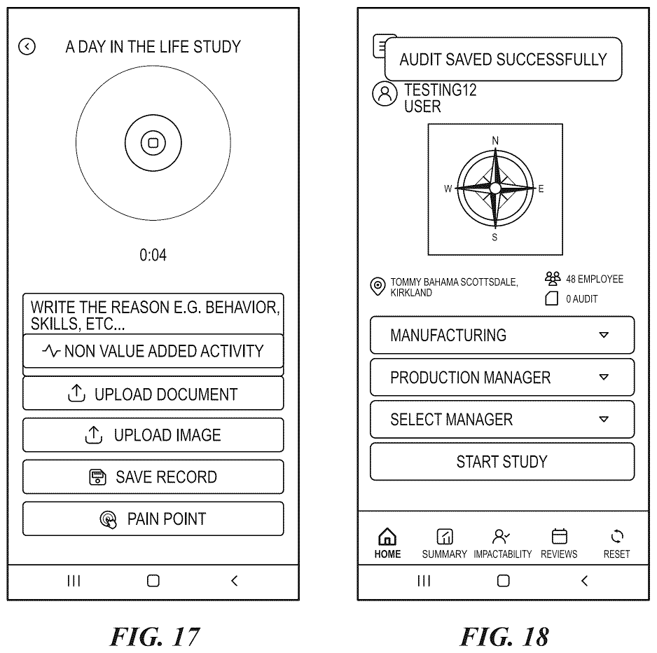

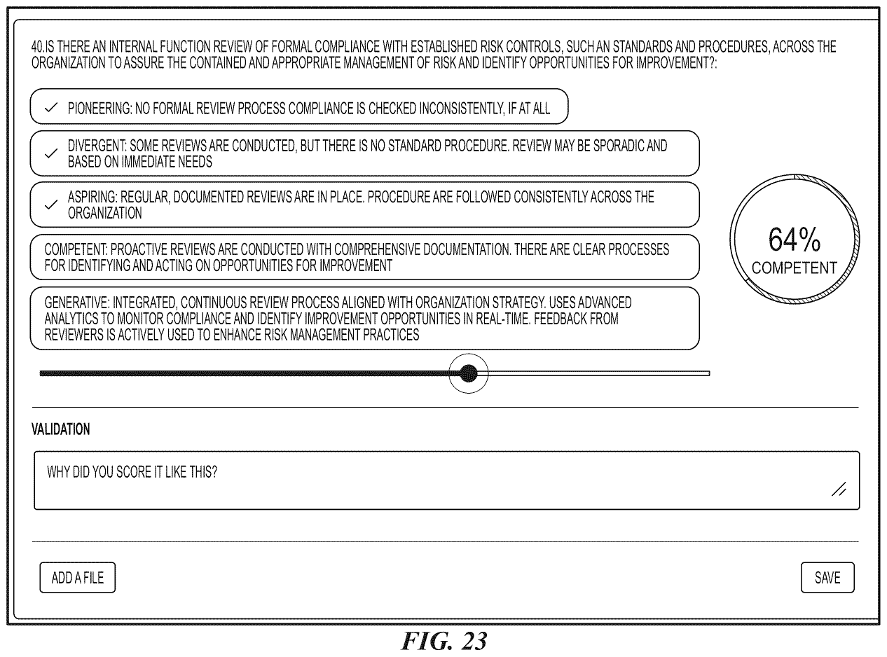

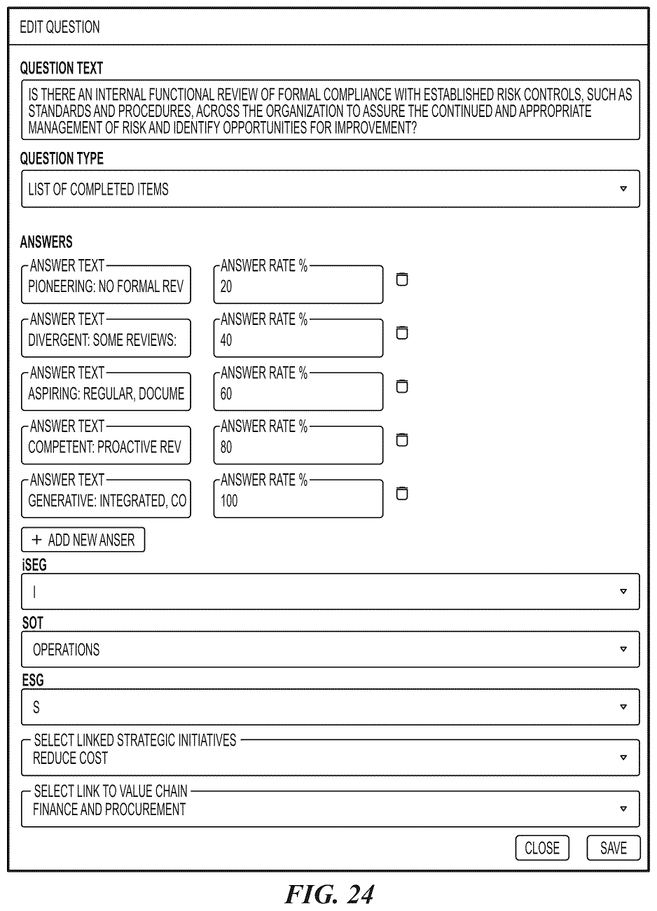

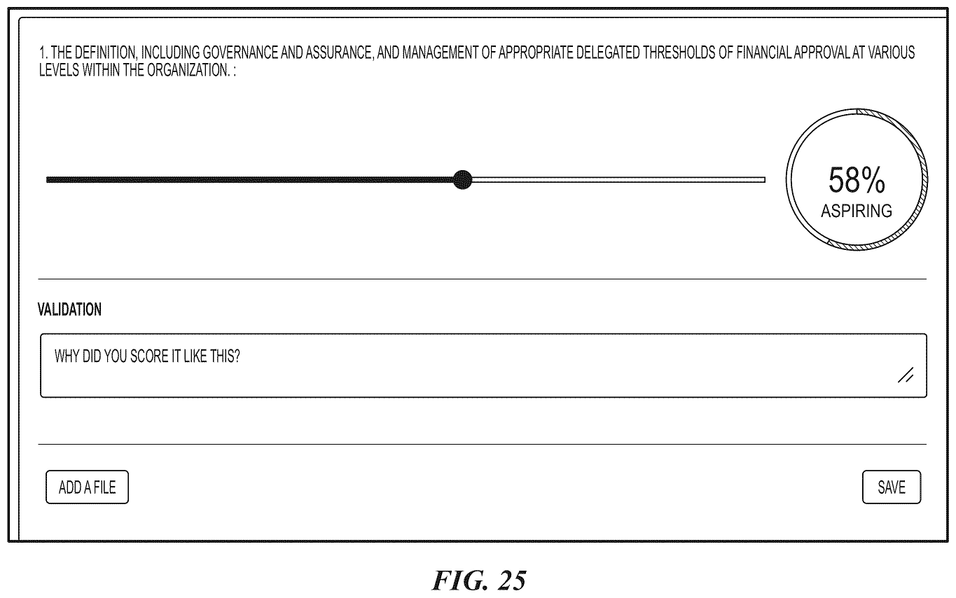

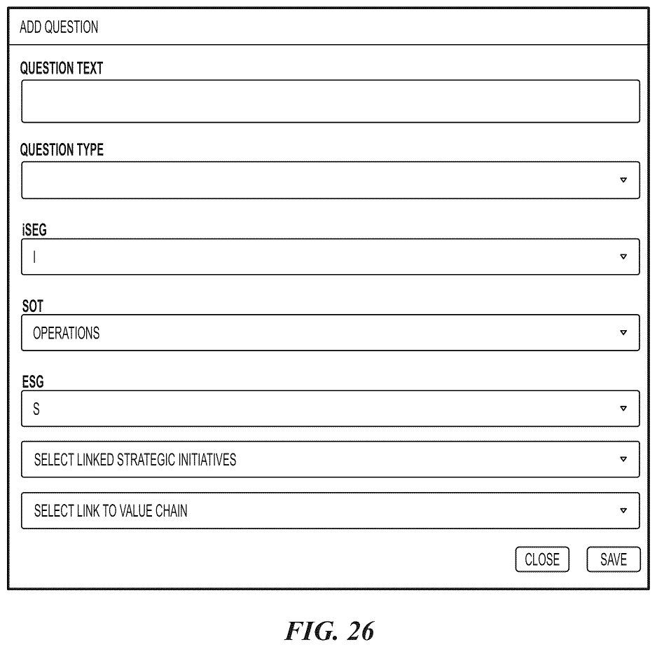

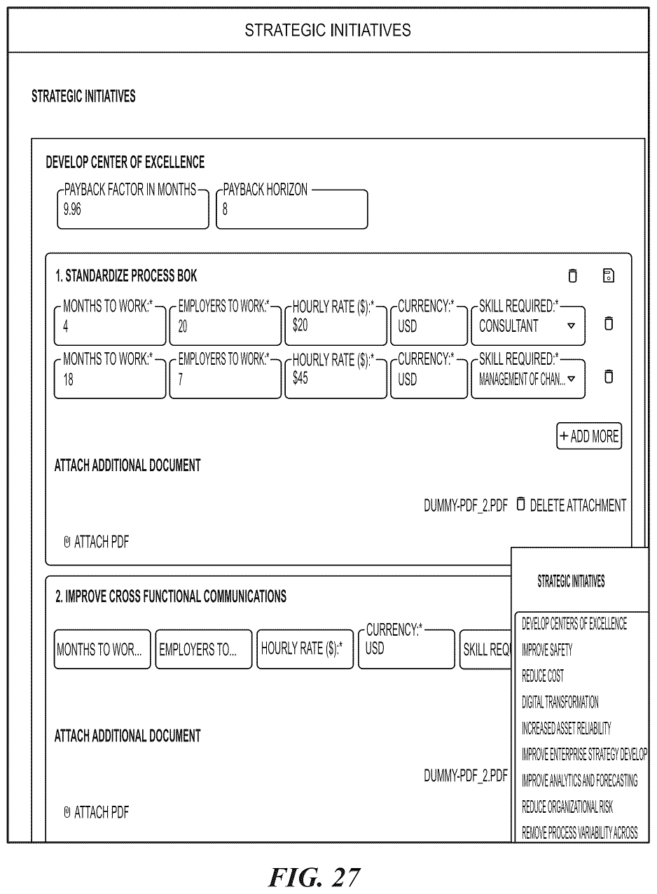

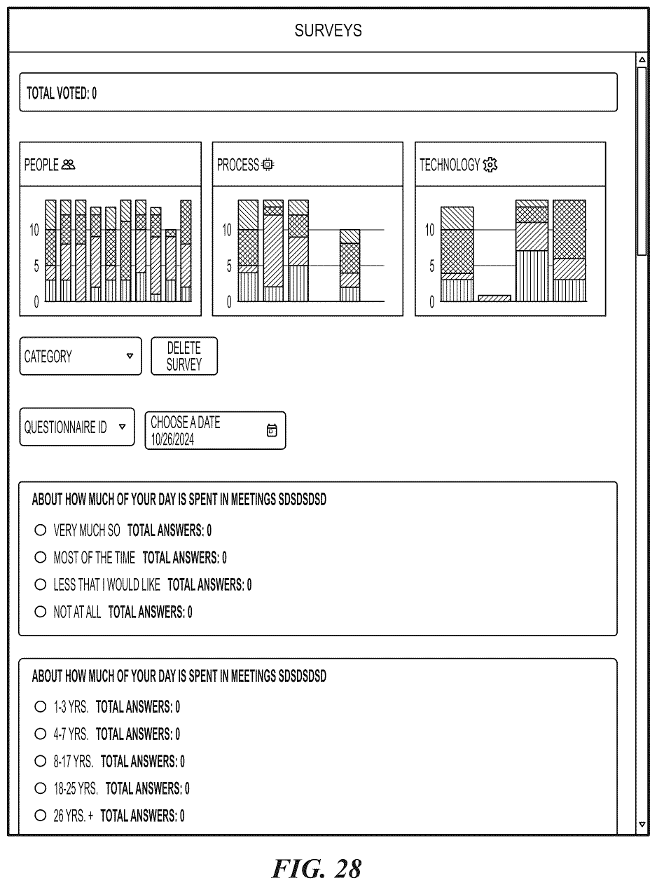

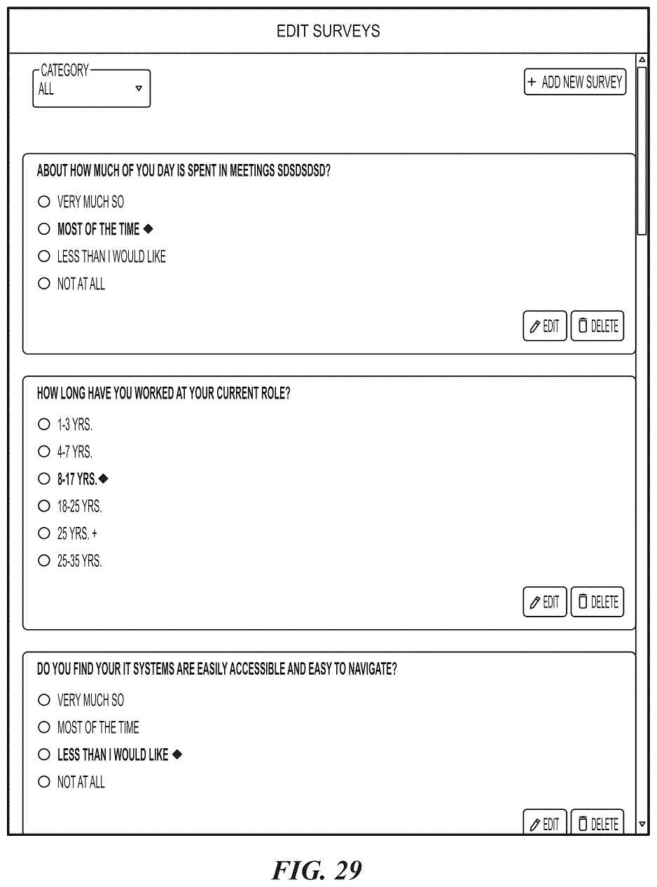

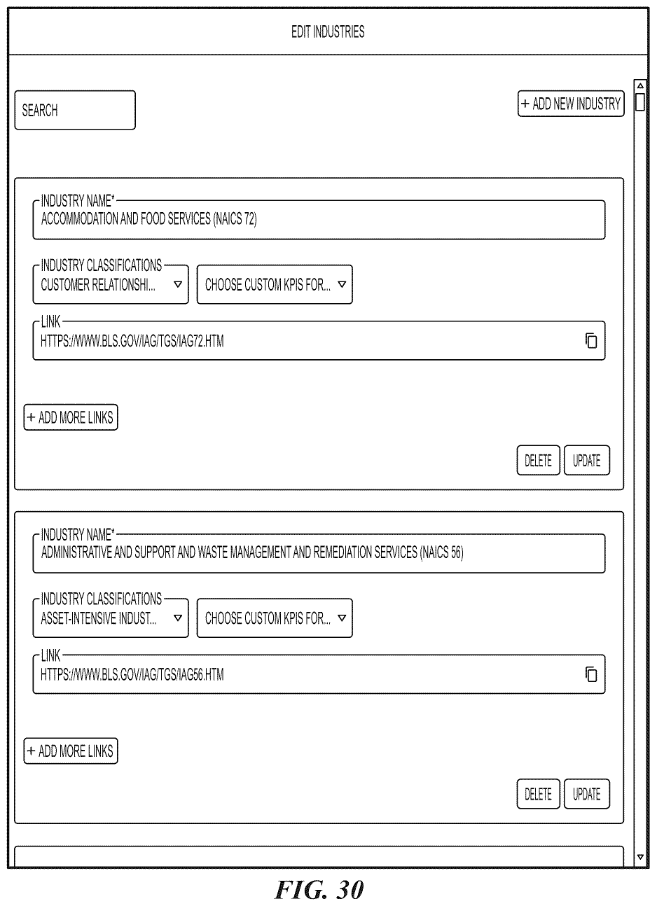

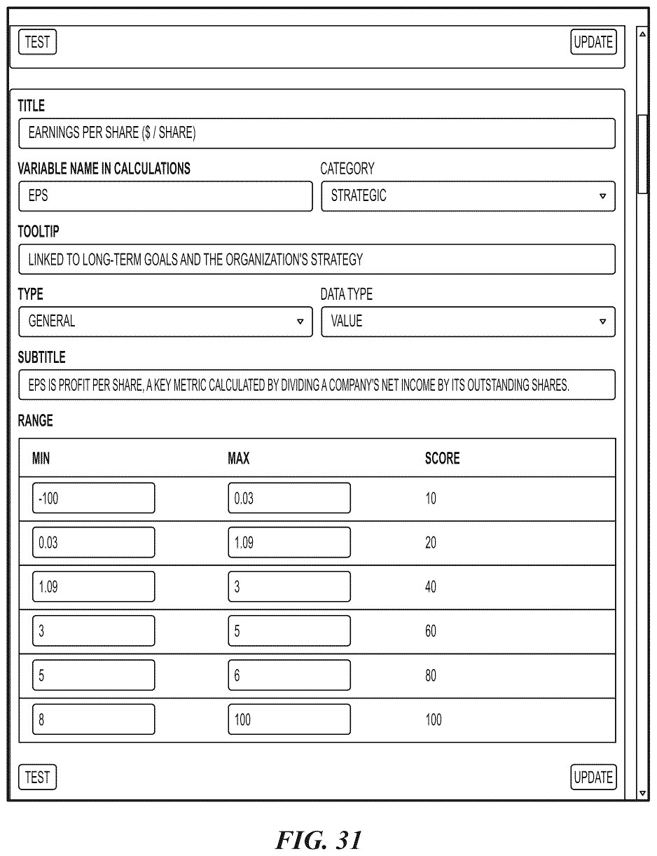

FIGS. 6-33 illustrates exemplary screenshots of the user interface which may be used by users of the system to enable the performance of the various tasks described herein. In particular, FIGS. 6-8 illustrate dashboard interfaces which displays scores, surveys, key measurements, investment and monetary metrics, and other information which allows the user to view the status of a business, project, or aspects thereof. This ability to analyze and interpret data, providing real-time insights into the health of an organization's processes. Our machine learning algorithms can identify patterns, anomalies, and opportunities for improvement that might be missed through traditional methods alone. The system may implement a “four pillar approach” which scores and analyzes intent, stewardship, ecosystem and growth to highlight specific pain points where improvement is needed and/or is most effective. Upon completion of the gap analysis, users can reveal pain points and monitor progress in removing process blockers.

The system includes various architecture components including a user interface layer, application layer, AI and analytics layer, data management layer, integration layer and reportion and insights layer. The application layer Contains all core business logic and workflow engines that drive the SaaS functionalities, especially the roadmap generation, AI-driven insights, and multi-site tracking. The AI and analytics layer provides insights and recommendations. The integration layer connects the system with external system for data exchange and enrichment. The reportion and insights layers generates reports and visualizations of KPIs, roadmaps progress, and illustrates strategic insights.

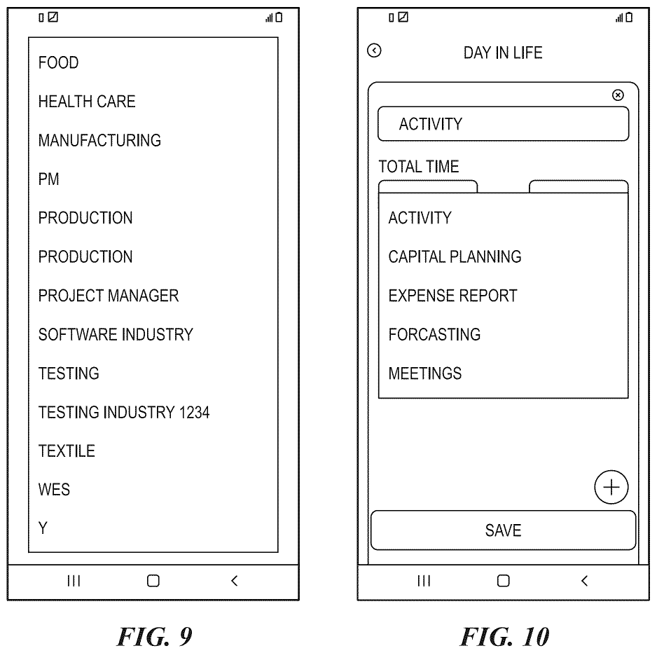

FIGS. 9-18 illustrate various user interfaces for completing a survey, uploading documents and recording, and otherwise inputting valuable information into the system. During registration, the application can cause at least a portion of a plurality of strategic initiatives to be presented for selection. As shown, more than one strategic initiative can be selected by a user. Upon selection, the application can receive a selection of at least one strategic initiative. The application can further request that a user provide input to indicate an industry of the organization they wish to transform, the age of the organization, a project name associated with the organization transformation, one or more locations of the organization, and the number of members of the organization.

The application can cause a dashboard to be presented. The dashboard can include one or more links to industry statistics, surveys, KPIs, a work breakdown structure overview, an exported document having comma separated values, and a strategic roadmap. The dashboard can include one or more scores determined by the application for the organization, including an overall score, an intent score, a stewardship score, an ecosystem score, and a growth score denoting organization areas of effort. The dashboard can include an overall classification of the organization based on the overall score. Additionally, or alternatively, the application can cause one or more progress indicators to be presented, wherein each progress indicator indicates the progress of a group of members of the organization in completing at least one process associated with the selected at least one strategic initiative. Any score or any progress of any process can be indicated using any suitable number, letter, character, symbol, etc., or any combination thereof. In some embodiments, a score or progress can be represented by a corresponding percentage.

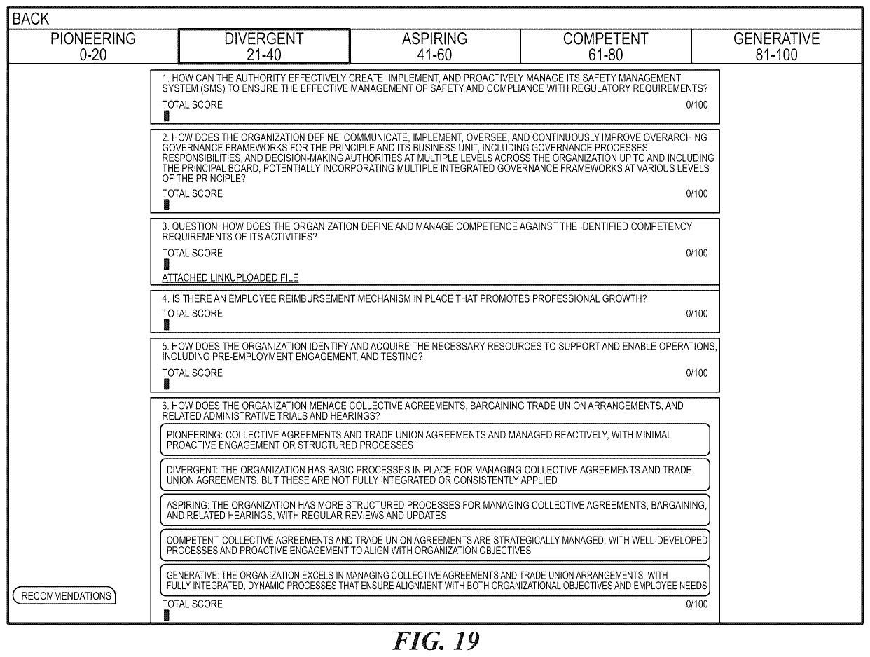

FIG. 19 illustrates a questionnaire interface wherein the user can view a maturity score, view AI recommendations, and interact with a questionnaire provided by the system. The system may utilize weights questions designed to evaluate the organization across key domains (i.e., the four pillars). The weighted questions allow the platform to emphasize areas that have a more significant influence on organizations performance to ensure critical factors are given appropriate attention.

The platform presents a series of questions related to the four strategic domains. Each question is assigned a weight based on its perceived importance to overall organizational health. Respondents provide answers to these questions, reflecting their insights and experiences within the organization. Responses are scored, and the assigned weights are applied to calculate a weighted score for each question. This approach ensures that more critical areas have a proportionally greater impact on the overall assessment outcome. The platform aggregates the weighted scores to generate a comprehensive analysis, identifying strengths and areas for improvement. This analysis informs the development of strategic roadmaps and action plans.

By focusing on high-impact areas, the assessment provides a more precise reflection of the organization's strategic health. The weighting system ensures that the evaluation aligns with the organization's priorities and strategic goals, facilitating targeted improvements. Organizations can allocate resources more effectively by concentrating efforts on areas identified as most critical through the weighted assessment.

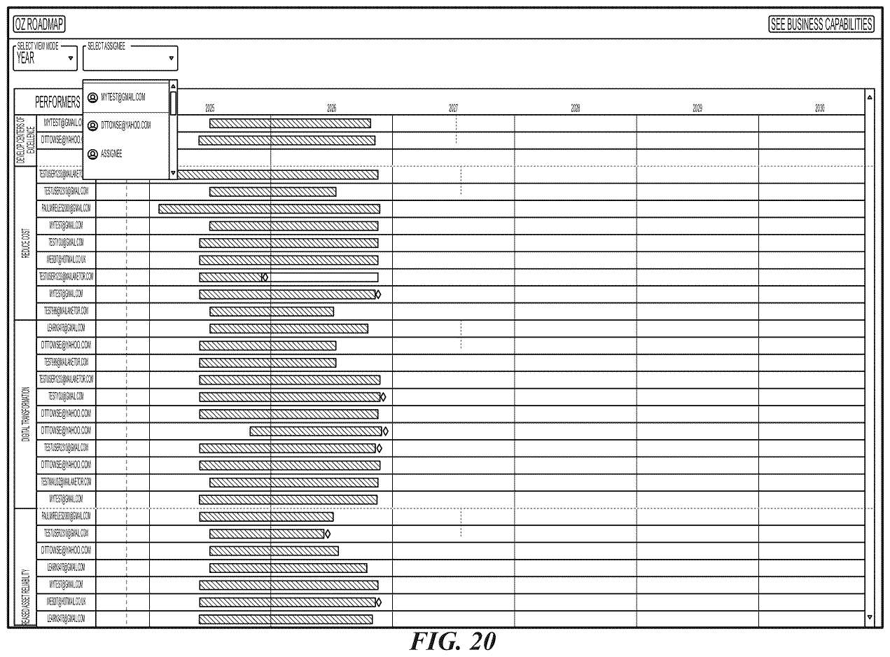

FIG. 20 illustrates a roadmap interface wherein progress updates are provided as well as a visualization of tasks, activities, pain points, and other metrics. Inflection indicators provide a visualization of a time period or event in which the particular activity will see progressive benefits towards the overall score.

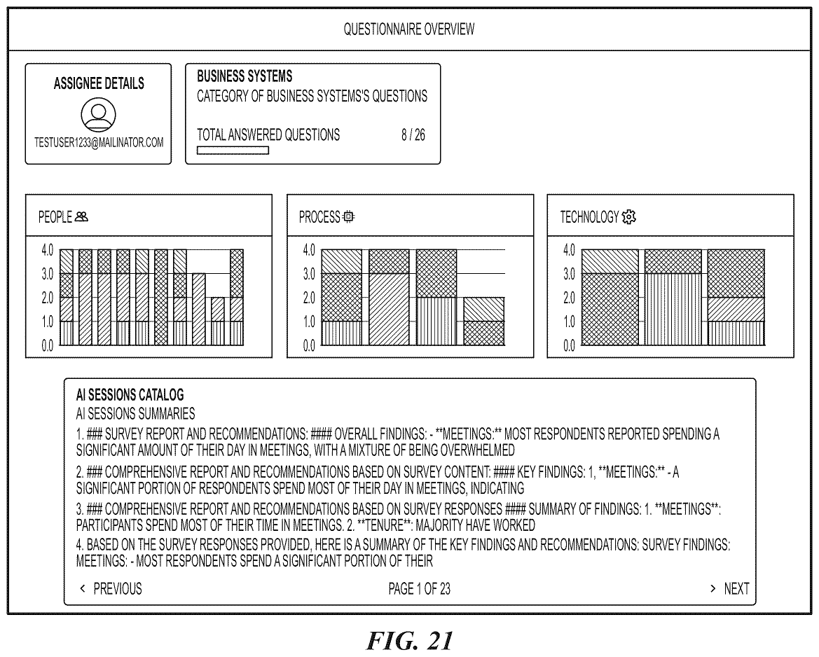

FIG. 21 illustrates a survey results interface which provides a graphical display and/or contextualized reports gained from the completion of a survey. This may include AI recommendations for improving key elements identified by the completion of the survey.

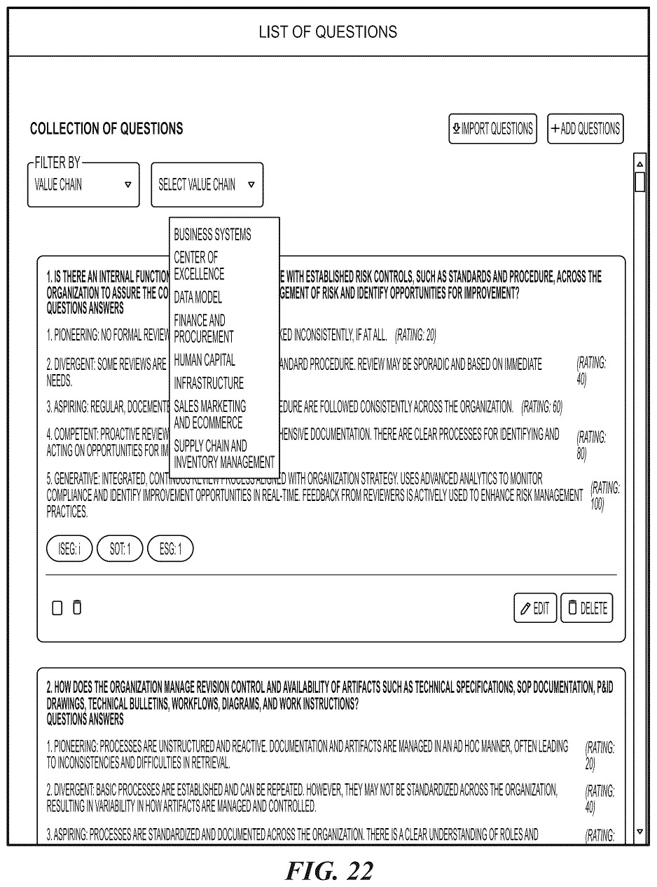

FIGS. 22-31 illustrate various elements of the questions, survey, and industry interfaces wherein users may edit questions, input questions, input responses, and otherwise interact and modify survey questions and responses thereto.

In some embodiments, users add prompts and run response queries base on the system's algorithm to understand root cause of business system performance. This primarily based on the four pillars of intent, stewardship, ecosystem and growth. Business capabilities are identified for each domain variable. Scores are averaged across the assessment tool along with the addition of survey and DILO calculations to provide one normalized value as overall score.

The questionnaire is a comprehensive assessment tool designed to evaluate a company's strategic health across four key domains: Intent, Stewardship, Process Ecosystem, and Growth. This structured approach enables organizations to identify gaps between current practices and best-in-class standards, facilitating the development of targeted strategies for improvement.

In some embodiments, AI assesses each value chain component's performance against industry metrics, helping the organization understand competitive standing.

The application can cause one or more inquiries associated with a selected strategic initiative and a value chain process to be presented in response to receiving a selection of a strategic initiative and a selection of value chain process. The application can assign a value chain process and its associated inquiries to one or more selected user accounts. In response to assigning a value chain process and its associated inquiries, the application can cause the one or more inquiries associated with the selected strategic initiative and the value chain process to be presented at one or more user devices associated with the assigned user accounts. The application can allow each user to provide input indicating a response to the one or more inquiries. The response can include a score. The response can include text that indicates the reasoning for any score provided by the user. After the responses are submitted, the application can receive the responses to the one or more inquiries. The application can send the one or more inquiries to the user devices periodically to determine a progress of the organization.

The application can allow a user to create, modify, or delete, one or more inquiries associated with a selected value chain process. The user can provide input to indicate any text of the one or more inquiries. The user can provide input to associate the one or more inquiries with one or more metrics and with at least one strategic initiative. The one or more metrics can include an intent metric, a stewardship metric, an ecosystem metric, a growth metric, a strategic metric, an operations metric, a tactical metric, an environment metric, a social metric, a governance metric, any other suitable metrics for an organization, or any combination thereof.

When the one or more inquiries are responded to by one or more assigned users, one or more scores of the one or more metrics can be determined based at least on the responses to the one or more inquiries and any associations between the one or more inquiries and the one or more metrics. In some embodiments, the one or more scores can be weighted based on the industry selected by a user. In some embodiments, the inquiries can be based on KPIs and empirical data about the performance of multiple organizations in multiple industries during any suitable period.

The application can cause a survey of questions to be presented at a plurality of user devices. The application can determine associations between the questions and the one or more metrics before causing the survey of questions to be presented. After receiving responses to the survey of questions from each of the plurality of user devices, the application can determine the one or more scores of the one or more metrics based at least on the responses to the survey from the plurality of user devices and the associations between the questions and the one or more metrics. The application can send surveys to a plurality of user devices periodically to determine a progress of the organization. In some embodiments, the survey questions can be based on KPIs and empirical data about the performance of multiple organizations in multiple industries during any suitable period.

The application can allow a user to create, modify, or delete one or more questions to be included in a survey of questions. The user can provide input to indicate any text of a survey question. The user can provide input to associate one or more metrics with any question, the type of response available (e.g., single selection response, a multiple selection response, a text response), and the text to be included in the response.

The application can present one or more scores of the one or more metrics on the dashboard. In some embodiments, the one or more scores can be presented in any suitable format, such as, for example, a numerical format. In some embodiments, the one or more scores can be presented in any suitable graphical representation, such as, for example, a bar chart, a pie chart, a line chart, a scatter plot, etc.

The application can cause a graphical representation of a work breakdown structure of the organization to be presented as a radar chart. The work breakdown structure can include the one or more scores of the one or more metrics. In some embodiments, the application 135 can group the one or more scores based on the one or more metrics.

The application can cause values of one or more KPIs to be presented. The values of the one or more KPIs can be based on responses to any survey, responses to any inquiry, or any combination thereof.

Each value chain process can be associated with one or more subprocesses. The application can allow a user to create, delete, or modify a subprocess of any value chain process. A user can provide input to indicate, for each subprocess, an estimated number of months for completing the subprocess and a number of members to be assigned to the subprocess.

The application can cause a strategic roadmap to be presented. The strategic roadmap can include a graphical representation of the subprocesses of any value chain process, an expected timeline associated with each subprocess, and the user accounts associated with each subprocess. The timelines can indicate a progress of each subprocess expressed in any suitable format, such as, for example, a percentage. The timelines can share a common time axis indicating the months and year in which the subprocesses are to be performed. The beginning time and the end time of each timeline can be modified. Each timeline can be moved so that the beginning time and the end time are moved simultaneously according to user input such as, for example, dragging a timeline using a cursor.

The application can allow a user to provide input that indicates the progress of any subprocess. After updating the progress of any subprocess, the associated timeline of the subprocess in the strategic roadmap can be updated to indicate the updated progress provided by the user.

The application program may utilize the analysis module and/or the scoring module to determine any of the following scores which can be presented for single business entities, multiple business entities specific or general locations and the like.

An intent score can indicate if the organization is progressing according to one or more intents of the organization (e.g., strategic initiatives). The intent score can be based on documents, standards, and communications that identify any the intent of the organization's management principles. The intent score can indicate if environmental, social and growth initiatives are directed towards objectives that are obtainable. The intent score is the normalization of the corporate mission, vision, value statement in the business culture to the extents of promoting business activities.

A stewardship score can indicate a measurement of stewardship of the organization. The stewardship score can be based on documented artifacts of the members of the organization, and/or on the amount of impact the members of the organization have on the organization. In some embodiments, the stewardship score is a measurement of leadership abilities through surveys, interviews, and industry benchmarking. The stewardship score can be based on the performance of selected members of an organization, how activities are handed off to ancillary processes, and how departments or business units interact with each other. The stewardship score can be based on workload variances, the retention of empirical data, and the amount of cooperation between locations and workstreams. The stewardship score can be based on the monetary compensation given to all members of the organization, including salary data from BLS.

An ecosystem score can indicate a measurement of resiliency of the organization in responding to business demands. The ecosystem score can indicate if the organization is lacking any physical resources. Physical resources of an organization can include offices, factories, information technology (IT) systems, functional data models, as well as management control and reporting systems.

A growth score can indicate a measurement of the organization's progress in each of the value chain processes. In some embodiments, the growth score is an average score of the progress scores of the value chain processes of the organization. And with a calculation that includes an AI query integrated into the score.

An environment score can indicate a measurement of the organization's carbon footprint. The environment score can be a measurement of the organization's adherence to environmental regulations, industry standards and their own business systems. The environment score can be based on the organization's carbon emissions, waste management, pollution control levels, and efforts to mitigate environmental harm.

A social score indicates a measurement of the organization's impact on society, community evolvement and stewardship and social responsibility initiatives.

A governance score indicates how the organization is managed and governed. The governance score can be based on the composition of the board of directors, executive compensation, transparency in financial reporting, ethical business practices, and adherence to legal and regulatory requirements.

A maturity score is a lexicon that indicates level of maturity in regards to business capabilities within each value chain tranche.

A logistics score can indicate the efficiency and effectiveness of the logistics of the organization. Logistics can include both inbound and outbound of finished goods, raw material, consumables, and inventories required to produce goods and service.

A production and operations score can indicate the efficiency and effectiveness of the organization's creation of goods and services.

A sales and marketing score can be based on the organization's activity of promoting goods and services or a brand of the organization.

A systems score can be based on the availability of tangible and nontangible assets that enable connectivity between the entire value chain. These systems include software, management control, key performance indicators (KPIs), IT landscape of business services, internal audit, workflows, industry standards, and standard operating procedures.

The application can determine any additional scores based on a comparison between any combination of scores.

In some embodiments, the application can assign weights to any score based on the industry of the organization. For example, an organization in the oil or automotive industry may have scores related to its physical assets weighted higher than other scores.

In some embodiments, the application can determine a level of effort required to transform the organization by departments or levels in the organization.

In some embodiments, the application can generate a comprehensive gap analysis based on the value chain processes.

In some embodiments, the application can integrate with any other suitable mobile applications that providing tactical analysis of any roles within the organization. The application 135 can integrate with any project management software.

In some embodiments, the application can include an artificial intelligence (AI) component that is configured to generate an industry forecast. The AI component can include any suitable AI technology, such as, for example, machine learning, natural language processing (e.g., large language models), speech recognition, deep learning (e.g., neural networks), natural language generation (e.g., GENERATIVE PRE-TRAINED TRANSFORMER (GPT)), semantic analysis, any AI classifier, or any combination thereof.

In some embodiments, the application is configured to generate evidence-based gap analysis.

In some embodiments, the application can identify one or more root causes of organization struggles or performance issues.

In some embodiments, the application allows users to associate business artifacts (e.g., documents, files, emails, correspondence) with any inquiry, question, value chain process, subprocess response, score, or any combination thereof. The business artifacts can be used as supporting documentation.

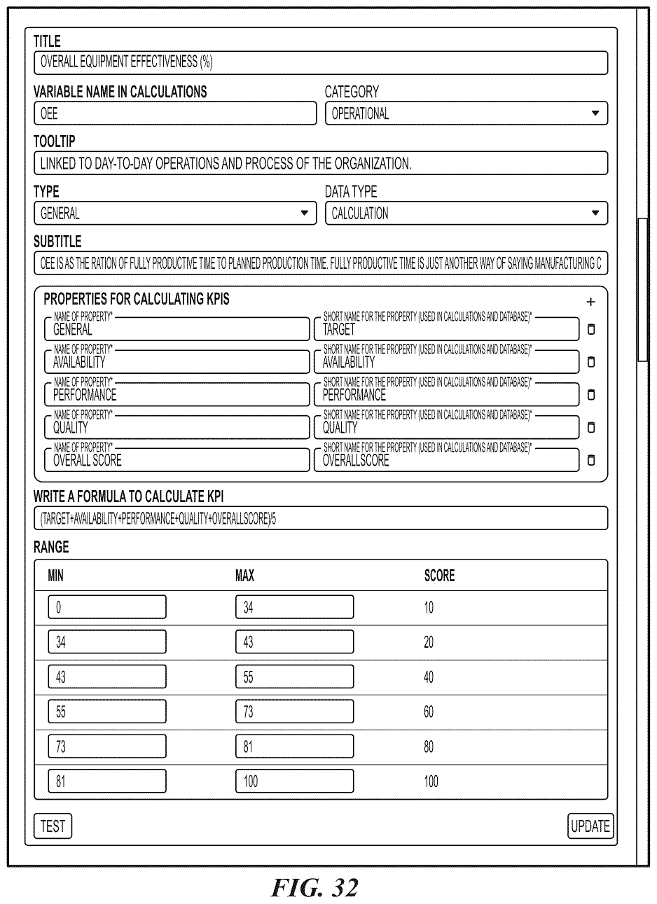

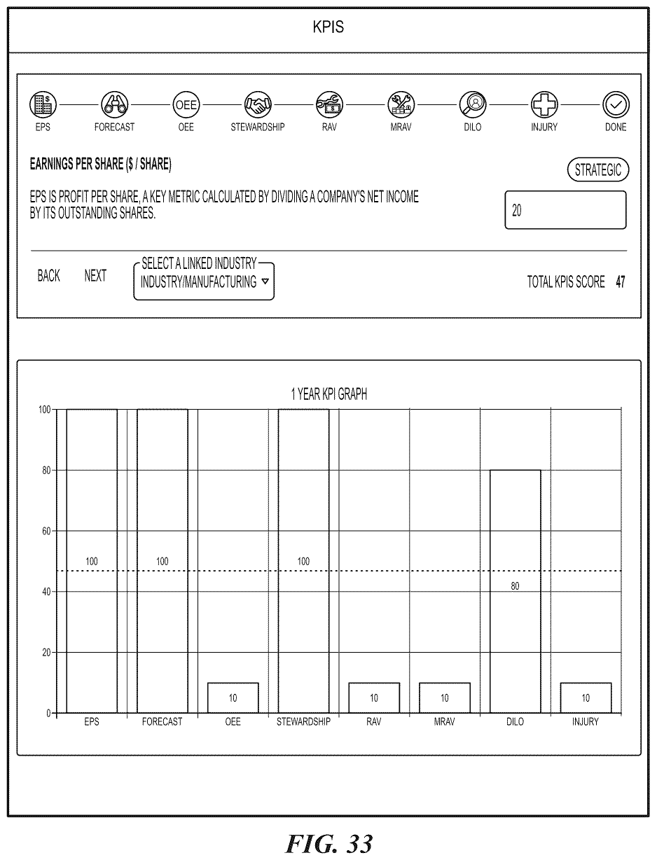

FIG. 32 illustrates the backend KPI interface while FIG. 33 illustrates the KPI analysis and reporting interface wherein KPIs are visually represented. KPIs can includes DILO, market share, injury rates, and other useful metrics. DILO relates to a Day in the Life study in which the assessors follows the subject through a typical day, observing and recording events to build up a realistic picture of what actually happens. Mapping a “Day in the Life” can illustrate graphically how time is assigned to various non-value and value added activities. Activities are then analyzed as Value or Non-Value added time and broken down further determining root cause analysis for impactability.

Market Share is the percent of total sales in a specific industry generated by a particular company and is a measurement of how much one company controls an entire industry. Market share is calculated by dividing the company's total revenues by the total sales of the whole industry during a specific period of time.

The Total Case Incident Rate/Total Recordable Incident Rate formula considers the total number of incidents and the total hours worked by all employees within one year.

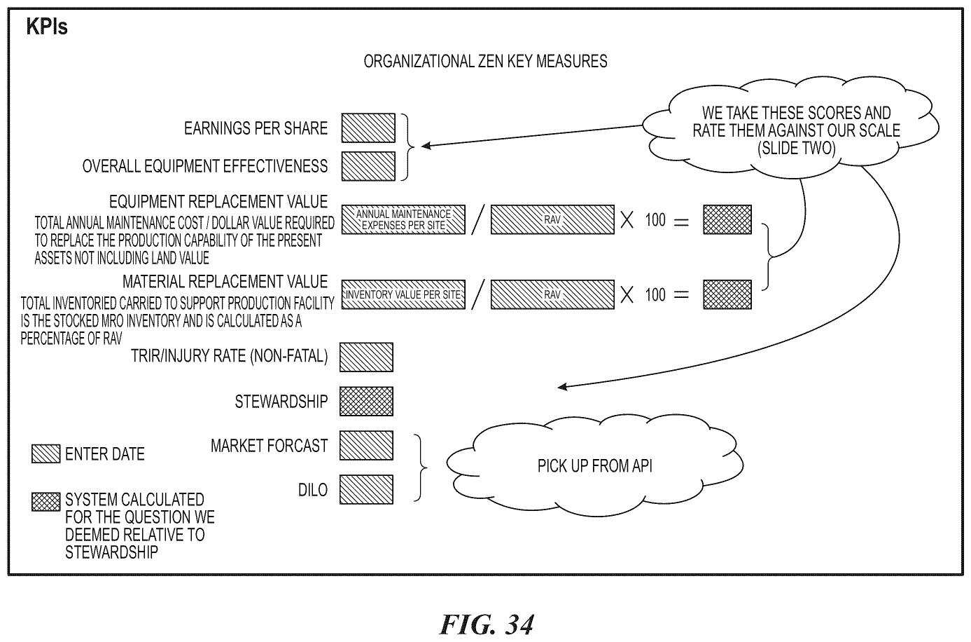

FIG. 34 illustrates a schematic of a method for calculating key measures assessed by the system.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the arts.

What is claimed is:

1. A system for the automated analysis of business operations, the system comprising:
at least one user computing device in operable connection with a user network;
an application server in operable communication with the user network, the application server configured to host an application program for generating an automated analysis of a plurality of business operations, the application program in operable communication with one or more processors coupled to a memory, wherein the one or more processors are configured to:
associate a respective group of inquiries of a plurality of inquiries with each of a plurality of strategic initiatives;
cause at least a portion of the plurality of strategic initiates to be presented for selection;
receive a selection of at least one strategic initiative of at least the portion of the plurality of strategic initiatives;
cause at least a portion of a group of inquiries associated with the selected at least one strategic initiative to be presented;
receive a response to at least the portion of the group of inquiries;
associate each inquiry of at least the portion of the group of inquiries with one or more metrics;
determine one or more scores of the one or more metrics associated with at least the portion of the group of inquiries, wherein the one or more scores are based on the response to at least the portion of the group of inquiries; and
cause a progress indicator to be presented, wherein the progress indicator indicates a progress of a group of members of an organization in completing at least one process associated with the selected at least one strategic initiative.

2. The system of claim 1, wherein the one or more processors are further configured to:
cause a survey of questions to be presented on a display of the at least one user computing device; and
receive a response to the survey of questions from each of the plurality of the at least one user computing device.

3. The system of claim 1, wherein the one or more metrics is comprised of at least one of the following: a strategic initiative metric, a safety metric, a transformation metric, a reliability metric, a strategy metric, a profitability metric, and a personnel metric.

4. The system of claim 1, wherein the one or more scores is comprised of the following:
an intent score, a stewardship score, an ecosystem score, a growth score, an environment score, a social score, a governance score, a maturity score, a logistics score, a production and operations score, a sales and marketing score, and a systems score.

5. The system of claim 1, further comprising an artificial intelligence engine to receive the response and to analyze the response to generate the one or more scores, wherein the artificial intelligence engine is operable to model on the one or more strategic initiatives within a multi-value-chain framework, wherein the artificial intelligence evaluates one or more dependencies to align each of one or more value chains using the evaluation of one or more resource requirements, the evaluation of one or more payback periods, and wherein the artificial intelligence engine recommends adjustments for enhanced interdepartmental collaboration.

6. The system of claim 5, wherein the artificial intelligence engine provides an automated and continuous feedback loop, via a feedback loop module, to align one or more organizational processes across four domains, and wherein the feedback loop module monitors each of the four domains for deviations, identifies root causes, and provides adjustments using real-time data inputs.

7. The system of claim 1, further comprising a timeline module to display one or more timelines associated with each of the one or more metrics, wherein the one or more timelines provide an estimated time for enacting a change to the business operations.

8. The system of claim 1, further comprising a reporting module to display, via a display module, one or more graphic representations of the one or more scores.

9. The system of claim 1, further comprising a KPI benchmarking system in operable communication with the artificial intelligence engine to analyze and compare the one or more metrics against one or more industry standards.

10. The system of claim 9, further comprising a day-in-the-life (DILO) study integration module to provide a map of user workflows and to categorize activities into value added and non-value added time to identify one or more root causes of workflow inefficiencies, wherein the artificial intelligence engine to identify one or more pain points.

11. A method for the automated analysis and characterization of business operations, the method comprising the steps of:
associating a group of inquiries of a plurality of inquiries with each strategic initiative of a plurality of strategic initiatives;
causing at least a portion of the plurality of strategic initiatives to be presented for selection;
receiving a selection of at least one strategic initiative of at least the portion of the plurality of strategic initiatives;
causing at least a portion of a group of inquiries associated with the selected at least one strategic initiative to be presented;
receiving a response to at least the portion of the group of inquiries;
associating each inquire of at least the portion of the group of inquiries with one or more metrics;
determining one or more scores of the one or more metrics associated with at least the portion of the group of inquiries, wherein the one or more scores are based on the response to at least the portion of the group of inquiries; and
displaying a progress indicator to be presented, wherein the progress indicator indicates a progress of a group of members of an organization in completing the at least one process associated with the selected at least one strategic initiative.

12. The method of claim 11, wherein the one or more processors are further configured to:
cause a survey of questions to be presented on a display of the at least one user computing device; and
receive a response to the survey of questions from each of the plurality of the at least one user computing device.

13. The method of claim 11, wherein the one or more metrics is comprised of at least one of the following: a strategic initiative metric, a safety metric, a transformation metric, a reliability metric, a strategy metric, a profitability metric, and a personnel metric.

14. The method of claim 11, wherein the one or more scores is comprised of the following: an intent score, a stewardship score, an ecosystem score, a growth score, an environment score, a social score, a governance score, a maturity score, a logistics score, a production and operations score, a sales and marketing score, and a systems score.

15. The method of claim 11, further comprising an artificial intelligence engine to receive the response and to analyze the response to generate the one or more scores, wherein the artificial intelligence engine is operable to model on the one or more strategic initiatives within a multi-value-chain framework, wherein the artificial intelligence evaluates one or more dependencies to align each of one or more value chains using the evaluation of one or more resource requirements, the evaluation of one or more payback periods, and wherein the artificial intelligence engine recommends adjustments for enhanced interdepartmental collaboration.

16. The method of claim 15, wherein the artificial intelligence engine provides an automated and continuous feedback loop, via a feedback loop module, to align one or more organizational processes across four domains, and wherein the feedback loop module monitors each of the four domains for deviations, identifies root causes, and provides adjustments using real-time data inputs.

17. The method of claim 11, further comprising a timeline module to display one or more timelines associated with each of the one or more metrics, wherein the one or more timelines provide an estimated time for enacting a change to the business operations.

18. The method of claim 11 further comprising a reporting module to display, via a display module, one or more graphic representations of the one or more scores.

19. The method of claim 11, further comprising a KPI benchmarking system in operable communication with the artificial intelligence engine to analyze and compare the one or more metrics against one or more industry standards.

20. The method of claim 11, further comprising a day-in-the-life (DILO) study integration module to provide a map of user workflows and to categorize activities into value added and non-value added time to identify one or more root causes of workflow inefficiencies, wherein the artificial intelligence engine to identify one or more pain points.

21. A non-transitory computer-readable medium including one or more instructions that, when executed by one or more processors, cause the one or more processors to perform a method comprising the steps of:
Associating, via a survey module, a group of inquiries of a plurality of inquiries with each strategic initiative of a plurality of strategic initiatives;
display, via a display module, at least a portion of the plurality of strategic initiatives for selection;
receiving, from a user input module, a selection of at least one strategic initiative of at least the portion of the plurality of strategic initiatives;
displaying, via the display module, at least a portion of a group of inquiries associated with the selected at least one strategic initiative;
receiving, from the user input module, a response to at least the portion of the group of inquiries;
associating each inquire of at least the portion of the group of inquiries with one or more metrics;
determining, via a scoring module, one or more scores of the one or more metrics associated with at least the portion of the group of inquiries, wherein the one or more scores are based on the response to at least the portion of the group of inquiries;
displaying, via the display module, a progress indicator, wherein the progress indicator indicates a progress of a group of members of an organization in completing the at least one process associated with the selected at least one strategic initiative; and
generating, via a report module, one or more reports related to the selected at least one strategic initiative, wherein the report includes a timeline, generated by a timeline module, to provide a time period for effecting a change associated with the at least one strategic initiative.
